(19) United States
(12) Patent Application Publication
(10) Pub. No.: US 2007/0111122 A1
(43) Pub. Date: May 17, 2007

(54) Photoreceptor with mixed crystalline phthalocyanine

(75) Inventor: Michel F. Molaire, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/281,953

(22) Filed: Nov. 14, 2005

(51) Int. Cl. G03G 5/06

(52) U.S. Cl. 430/59.5; 430/78; 430/96

(57) ABSTRACT

The present invention provides an electrophotographic element. The element has a charge generation layer including binder and, dispersed in the binder, a physical mixture of (1) a high speed cocrystallized mixture of TiOPc and TiOFPc having a first intensity peak at 7.4 with respect to X-rays characteristic of Cu Kα at a wavelength of 1.541 Å of the Bragg angle 2θ and a second intensity peak at 28.6°±0.2°, and (2) a low speed phthalocyanine pigment.

### FIELD OF THE INVENTION

The present invention relates generally to electrophotographic elements and methods for their preparation. More particularly, the present invention relates to electrophotographic elements having a charge generation layer including binder and, dispersed in the binder, a physical mixture of (1) a high speed co-crystallized mixture of unsubstituted titanyl phthalocyanine (TiOPc) and titanyl fluorophthalocyanine (TiOFPc), and (2) a low speed phthalocyanine pigment, and methods of preparing the same.

### BACKGROUND OF THE INVENTION

Reference is made to the following pending, commonly assigned applications, the disclosures of which are incorporated herein by reference: U.S. patent application Ser. No. 10/655,528, filed on Sep. 4, 2003, in the names of Molaire, et al., entitled “Self-Dispersing Titanyl Phthalocyanine Pigment Compositions And Electrophotographic Charge Generation Layers Containing Same”; U.S. patent application Ser. No. 10/655,388, filed on Sep. 4, 2003, in the names of Molaire, et al., entitled “Two-Stage Milling Process For Preparing Cocrystals Of Titanyl Fluorophthalocyanine And Titanyl Phthalocyanine, And Electrophotographic Element Containing Same”; U.S. patent application Ser. No. 10/655,113, filed on Sep. 4, 2003, in the names of Molaire, et al., entitled “Cocrystals Containing High-Chlorine Titanyl Phthalocyanine And Low Concentration Of Titanyl Fluorophthalocyanine, And Electrophotographic Element Containing Same”; U.S. patent application Ser. No. 10/655,289, filed on Sep. 4, 2003, in the names of Molaire, et al., entitled “Process For Forming Cocrystals Containing Chlorine-Free Titanyl Phthalocyanines And Low Concentration Of Titanyl Fluorophthalocyanine Using Organic Milling Aid”.

Electrophotographic recording elements containing phthalocyanine pigments as charge-generation materials are useful in electrophotographic laser printers because they are capable of providing good photosensitivity in the near infrared region of the electromagnetic spectrum, that is in the range of 700-900 nm. In grey level digital electrophotography, and especially in laser imaging, it is very important to match the photoconductor sensitivity to the writing system. This is not a simple problem. Consideration must be given to such factors as laser output energy, laser spot size, gray scale power levels, and temporal stability of the laser beam. The sensitivity of titanyl fluorophthalocyanine containing photoconductors can be adjusted. One way is by first selecting a charge generation material and their varying the thickness of the layer that contains that material. The photosensitivity is raised by increasing the thickness of the layer containing the charge generation material and lowered by reducing the thickness. This approach has limited utility, however, since it is only practical for a very narrow range of thicknesses. An excessively thin layer will not absorb enough light to permit charge erasure during an electrophotographic cycle. An excessively thick layer will not transport charges well. There is a further problem. This approach requires very close tolerances on the thickness of the layer containing the charge generating material. In manufacturing, such tolerances are likely to lead to greatly increased costs.

Another way of varying the sensitivity of titanyl fluorophthalocyanine containing photoconductors is by using a mixture of two different phthalocyanines. A number of references teach combining different titanyl phthalocyanines. Different combinations of titanyl phthalocyanines have produced widely differing results.

U.S. Pat. No. 4,882,427, to Enokida et al, teaches that noncrystalline or pseudo-noncrystalline phthalocyanine products produced from various mixtures of crude phthalocyanines had sensitivities about the same as that of a noncrystalline titanyl phthalocyanine.

U.S. Pat. No. 5,112,711, to Nguyen et al, teaches an electrophotographic element having a combination of titanyl phthalocyanine and titanyl fluorophthalocyanine. In U.S. Pat. No. 5,112,711, a combination of titanyl phthalocyanine and titanyl fluorophthalocyanine provided a synergistic increase in photosensitivity, while combinations of titanyl phthalocyanine and chloro- or bromo-substituted titanyl phthalocyanine produced results in which the photosensitivity was nearer that of the least sensitive phthalocyanine.

U.S. Pat. No. 5,039,586, to Itami, teaches that a photoreceptor could be made having a mixture of such crystalline forms of titanyl phthalocyanine, as α-TiOPc, β-TiOPc, mixed α and β-TiOPc, and amorphous TiOPc but does not indicate what electrophotographic characteristics would result.

U.S. Pat. No. 5,523,189 to Molaire teaches an electrophotographic element and a preparation method. The element has a charge generation layer including binder and, dispersed in the binder, a physical mixture of: a high-speed titanyl fluorophthalocyanine and a low speed titanyl fluorophthalocyanine. The high-speed titanyl fluorophthalocyanine has a first intensity peak with respect to X-rays characteristic of Cu Kα at a wavelength of 1.541 Å of the Bragg angle 2θ at 270°±0.2° and a second intensity peak at 7.3°±0.2°. The second peak has intensity relative to the first peak of less than 60 percent. The low speed titanyl fluorophthalocyanine has a first intensity peak with respect to X-rays characteristic of Cu Kα at a wavelength of 1.541 Å of the Bragg angle 2θ at 6.7°±0.2° and a second intensity peak at 23.7°±0.2°. The second peak has an intensity relative to the first peak of less than 50 percent.

The invention of U.S. Pat. No. 5,523,189 is illustrated in FIG. 1. and shows photosensitivity from 0.02 cm²/ergs to 0.40 cm²/ergs.

With the advance of faster and faster electrophotographic devices, there has been a need for higher sensitivity photoconductors.

U.S. Pat. No. 5,614,342 to Molaire et al, which is incorporated by reference herein in its entirety, teaches co-crystallized titanyl phthalocyanine-titanyl fluorophthalocyanine compositions, preparation methods, and electrophotographic elements utilizing the compositions. The method has the steps of: admixing crude titanyl phthalocyanine and crude titanyl fluorophthalocyanine to provide a pigment mixture; increasing the amorphousness of the pigment mixture as determined by X-ray crystallography using X-radiation characteristic of Cu Kα at a wavelength of 1,541 Å of the Bragg angle 2θ to provide an amorphous pigment mixture; contacting the amorphous pigment mixture with organic solvent having a gamma_{c} hydrogen bonding parameter of less than 8.0; and prior to the contacting, substantially excluding the amorphous pigment mixture from contact with organic solvent having a gamma hydrogen bonding parameter greater than 9.0.

An advantageous effect of at least some of the embodiments of the invention that compositions of matter, preparation methods and electrophotographic elements are disclosed that provide for good electrophotographic characteristics at reduced cost relative to titanyl fluorophthalocyanine.

U.S. Pat. No. 5,614,342 provides photosensitivity from 0.40 cm²/ergs to 1.0 cm²/ergs, as shown in FIG. 2.

U.S. patent application Ser. No. 10/655,113, filed on Sep. 4, 2003, in the names of Molaire, et al., entitled “Cocrystals Containing High-Chlorine Titanyl Phthalocyanine And Low Concentration Of Titanyl Fluorophthalocyanine, And Electrophotographic Element Containing Same”; discloses a process for forming an amorphous TiOPc/TiOFPc pigment mixture containing a low concentration of TiOFPc comprises: subjecting a mixture comprising phthalonitrile and titanium tetrachloride to reaction conditions effective to form lightly chlorine-substituted crude crystalline Cl—TiOPc, combining the lightly chlorine-substituted crude crystalline Cl—TiOPc with crude crystalline TiOFPc in a weight ratio from about 70:30 Cl—TiOPc:TiOFPc to about 99.5:0.5 Cl—TiOPc:TiOFPc to form a crude crystalline pigment mixture, and treating the crude crystalline pigment mixture under conditions effective to form a substantially amorphous pigment mixture of Cl—TiOPc and TiOFPc. It was found very difficult to mill substantially unsubstituted TiOPc at Wt ratio of TiOPc to TiOFPc above 75%. Reactions conditions by which a relatively small amount of ring-substituted chlorine can be introduced into a TiOPc pigment, resulting in a lightly chlorinated TiOPc, designated hereinafter as “Cl—TiOPc”. The small amount of ring-substituted chlorine introduced into TiOPc is enough to enhance its ease of grindability to form substantially amorphous Cl—TiOPc/TiOFPc pigment, even at concentrations of TiOFPc as low as about 0.5wt. %.

A deficiency of this approach is the fact that Cl—TiOPc is more expensive to manufacture than substantially unsubstituted TiOPc.

U.S. patent application Ser. No. 10/655,388, filed on Sep. 4, 2003, in the names of Molaire, et al., entitled “Two-Stage Milling Process For Preparing Cocrystals Of Titanyl Fluorophthalocyanine And Titanyl Phthalocyanine, And Electrophotographic Element Containing Same”; discloses a process of amorphizing highly crystalline TiOFPc-TiOPc mixtures containing a high concentration of substantially chlorine-free TiOPc. The present invention is directed to a process for forming an amorphous mixture consisting essentially of TiOFPc and TiOPc and containing more than 75 weight percent of substantially chlorine-free TiOPc. The process comprises: forming a mixture of crude crystalline TiOFPc and crude crystalline, substantially chlorine-free TiOPc that contains less than 75 weight percent TiOPc, treating the mixture under conditions effective to form a substantially amorphous mixture of TiOFPc and TiOPc containing less than 75 weight percent TiOPc, treating the substantially amorphous mixture with water, drying the mixture and adding a further amount of crude crystalline, substantially chlorine-free TiOPc sufficient to form a new mixture containing more than 75 weight percent of substantially chlorine-free TiOPc, and treating the new mixture under conditions effective to form a substantially amorphous mixture of TiOFPc and TiOPc containing more than 75 weight percent of substantially chlorine-free TiOPc.

U.S. patent application Ser. No. 10/655,289, filed on Sep. 4, 2003, in the names of Molaire, et al., entitled “Process For Forming Cocrystals Containing Chlorine-Free Titanyl Phthalocyanines And Low Concentration Of Titanyl Fluorophthalocyanine Using Organic Milling Aid”; discloses process for forming an amorphous pigment mixture consisting essentially of TiOPc and TiOFPc and containing more than about 75 weight percent of TiOPc, which is preferably substantially chlorine-free. he process includes: combining a mixture of crude crystalline TiOPc and TiOFPc pigments in a weight ratio of at least 75:25 TiOPc:TiOFPc with at least about 5 wt. %, based on the total weight of TiOPc and TiOFPc, of an organic milling aid, treating the mixture under conditions effective to form a substantially amorphous pigment mixture of TiOPc and TiOFPc containing at least about 75 weight percent TiOPc. The substantially amorphous pigment mixture can optionally be separated from the organic milling aid.

Further in accordance with both U.S. patent application Ser. No. 10/655,388 and U.S. patent application Ser. No. 10/655,289, a nanoparticulate cocrystalline composition is obtained by forming a slurry in an organic solvent of the substantially amorphous mixture of TiOPc and TiOFPc, and wet milling the slurry to form a nanoparticulate cocrystalline composition that consists essentially of TiOPc and TiOFPc and contains at least about 75 weight percent of TiOPc, which is preferably substantially chlorine-free.

More recently, this inventor has found that amorphous mixtures of TiOPc and TiOFPc with substantially chlorine-free TiOPc, having a TiOPc Wt ratio higher than 85%, upon contact with organic solvent tend to produce a mixture of crystals. Furthermore the relative ratio of the crystals in the mixture, tend to be unpredictable. Thus, the photosensitivity of such mixtures, are also unpredictable.

The procedures for the preparation of titanyl phthalocyanine pigments described in the foregoing patents, all of whose disclosures are incorporated herein by reference, suffer from various deficiencies and disadvantages.

There is a continuing need for electrophotographic elements having various photosensitivities. It is highly desirable to provide improved electrophotographic elements including more than one type of titanyl fluorophthalocyanine and providing various photosensitivities, specially photosensitivities higher than those of U.S. Pat. No. 5,523,189.

There is a further need to provide electrophotographic elements having various photosensitivities that are more economical.

There is yet further need to provide electrophotographic elements having various photosensitivities where the photosensitivities can be adjusted easily during the coating process by minor adjustment of the charge generation dispersion.

### SUMMARY OF THE INVENTION

It is an object of the invention to provide an electrophotographic element. The element has a charge generation layer including binder and, dispersed in the binder, a physical mixture of (1) a high speed cocrystallized mixture of TiOPc and TiOFPc having a first intensity peak at 7.4 with respect to X-rays characteristic of Cu Kα at a wavelength of 1.541 Å of the Bragg angle 2θ and a second intensity peak at 28.6°±0.2°, and (2) a low speed phthalocyanine pigment.

The present invention provides a coating composition having a mixture of a high-speed co-crystallized mixture of TiOPc and TiOFPc which exhibits peaks of the Bragg angle 2θ with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6° and a slow titanyl fluorophthalocyanine having a first intensity peak with respect to x-rays of Cu Kα at a wavelength of 1.541 Å of the Bragg angle 2θ at 27°, and a second intensity peak at 7.3°, said second peak having intensity relative to said first peak of less than 60 percent and a solvent.

The present invention also provides a coating composition having a mixture of a high speed cocrystallized mixture of TiOPc and TiOFPc which exhibits peaks of the Bragg angle 2θ with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6° and a slow TiOFPc having a first intensity peak with respect to X-rays characteristic of Cu Kα at a wavelength of 1.541 Å of the Bragg angle 2θ at 6.7 and a second intensity peak at 23.7 wherein the second intensity peak has an intensity relative to the first intensity peak of less than 50 percent.

The present invention provides a coating composition comprising a mixture of a high speed cocrystallized mixture of TiOPc and TiOFPc which exhibits peaks of the Bragg angle 2.theta. with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6° and a slow crystalline Cl—TiOPc exhibiting major peaks of the Bragg angle 2θ at 7.3°, 10.0°, 11.6°, 12.9°, 15.8°, 16.9°, 18.1°, 23.1°, 24.2°, 27.0°, and 31.17° and a solvent.

### BRIEF DESCRIPTION OF THE DRAWINGS

The above-mentioned and other features of this invention and the manner of attaining them will become more apparent and the invention itself will be better understood by reference to the following description of an embodiment of the invention taken in conjunction with the accompanying figures wherein:

FIG. 1 is a plot of photosensitivity Vs. Wt ratio of Fast TiOFPc to Low Speed TiOFPc (data from Table 2 of U.S. Pat. No. 5,523,129 to Molaire).

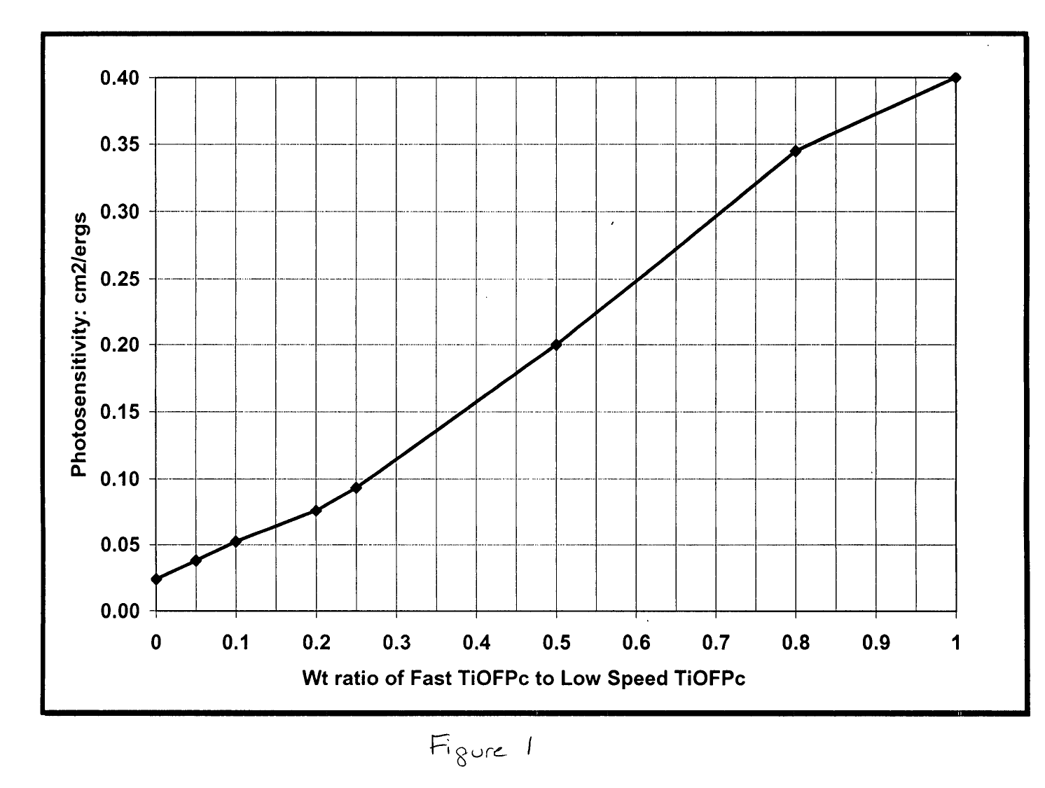

FIG. 2 is a plot of photosensitivity of Wt ratio of TiOFPc vs. TiOPc for Co-Crystallized TiOPc:TiOFPc mixture (data from Table 5 of U.S. Pat. No. 5,614,342 to Molaire et al).

FIG. 3 is an x-ray diffraction pattern that exhibits peaks of the Bragg angle 2θ with respect to x-rays of Cu κα at a wavelength of 1.541 Å, for raw Cl—TiOPc.

FIG. 4 is an x-ray diffraction pattern that exhibits peaks of the Bragg angle 2θ with respect to x-rays of Cu κα at a wavelength of 1.541 Å, for raw Cl-free TiOPc.

FIG. 5 is an x-ray diffraction pattern that exhibits peaks of the Bragg angle 2θ with respect to x-rays of Cu κα at a wavelength of 1.541 Å, for raw TiOFPc.

FIG. 6 is an x-ray diffraction pattern that exhibits peaks of the Bragg angle 2θ with respect to x-rays of Cu κα at a wavelength of 1.541 Å, for low speed Cl—TiOPc.

FIG. 7 is an x-ray diffraction pattern that exhibits peaks of the Bragg angle 2θ with respect to x-rays of Cu κα at a wavelength of 1.541 Å, for high-speed cocrystallzed 75:25 mixture.

FIG. 8 is an x-ray diffraction pattern that exhibits peaks of the Bragg angle 2θ with respect to x-rays of Cu κα at a wavelength of 1.541 Å, for high speed cocrystallized 85:15 Mixture.

FIG. 9 an x-ray diffraction pattern that exhibits peaks of the Bragg angle 2θ with respect to x-rays of Cu κα at a wavelength of 1.541 Å, for low-speed (low gamma_{c}) TiOFPc.

FIG. 10 is an x-ray diffraction pattern that exhibits peaks of the Bragg angle 2θ with respect to x-rays of Cu κα at a wavelength of 1.541 Å, for low-speed (high gamma_{c}) TiOFPc.

FIG. 11 is a graph of speed vs. the weight fraction of high-speed cocystallized 75:25 mixture to low-speed (low gamma_{c}) TiOFPc.

### DETAILED DESCRIPTION OF THE INVENTION

In the method of the invention a co-crystallized mixture of unsubstituted titanyl phthalocyanine and titanyl fluorophthalocyanine pigments and a phthalocyanine pigment are mixed to provide the phthalocyanine charge generation material, which has novel characteristics. This charge generation material, along with the remaining components of a coating composition, is coated to form the charge generation layer of an electrophotographic recording element of the invention.

It is a common practice for those in the art to refer to the product of a phthalocyanine preparation procedure as a “pigment”. This practice is followed herein.

The two different phthalocyanine pigments used in the method of the invention are referred to herein as “low speed phthalocyanine pigment” or “low speed pigment” and “high speed cocrystallized phthalocyanine pigment” or “high speed pigment”. The low and, high-speed pigments have different speeds or sensitivities, as discussed below in detail.

In one embodiment of the invention, the low speed phthalocyanine is a fluorophthalocyanine having a first intensity peak with respect to X-rays characteristic of Cu Kα at a wavelength of 1.541 Å of the Bragg angle 2θ at 6.7 and a second intensity peak at 23.7. The second peak has an intensity relative to the first peak of less than 50 percent. Crystallographic characteristics discussed herein, are based upon X-ray diffraction spectra at the Bragg angle 2θ using Cu Kα X-radiation at a wavelength of 1.541Å and are ±0.2° unless otherwise indicated. Suitable X-ray diffraction techniques are described, for example, in Engineering Solids, T. S. Hutchinson and D. C. Baird, John Wiley and Sons, Inc., 1963 and X-ray Diffraction Procedures for Polycrystalline and Amorphous Materials, 2nd Ed., John Wiley and Sons, Inc., 1974. This low speed pigment has an electrophotographic speed, determined as described below, in the range of from 0.01 to 0.07 cm²/ergs; or preferably from 0.013 to 0.04 cm²/ergs. This low speed titanyl fluorophthalocyanine pigment is referred herein as “low-speed (high gamma_{c}) TiOFPc”.

In another embodiment, the low speed phthalocyanine is titanyl fluorophthalocyanine having a first intensity peak with respect to X-rays characteristic of Cu Kα at a wavelength of 1.541 Å of the Bragg angle 2θ at 2.70°±0.2° and a second intensity peak at 7.30°±0.2°. The second peak has an intensity relative to the first peak of less than 60 percent. The low speed pigment has an electrophotographic speed, determined as described below, in the range of from 0.1 to 0.7 cm²/ergs; or preferably from 0.1 to 0.4 cm²/ergs. This low speed titanyl fluorophthalocyanine pigment is referred herein as “low-speed (low gamma_{c}) TiOFPc”.

In yet another embodiment, the low speed phthalocyanine is Cl—TiOPc exhibiting major peaks of the Bragg angle 2θ at 7.3°, 10.0°, 11.6°, 12.9°, 15.8°, 16.9°, 18.1°, 23.1°, 24.2°, 27.0°, and 31.17° (all ±0.2°). The low speed pigment has an electrophotographic speed, determined as described below, in the range of from 0.2 to 0.50 cm²/ergs; or preferably from 0.2 to 0.4 cm²/ergs. This low speed crystalline Cl—TiOPc pigment is referred herein as “low-speed Cl—TiOPc”

The high speed Co-crystallized titanyl phthalocyanine and Titanyl fluorophthalocyanine pigment mixture has first intensity peak at 7.4 with respect to X-rays characteristic of Cu Kα at a wavelength of 1.541 Å of the Bragg angle 2θ and a second intensity peak at 28.6°±0.2°. The high-speed pigment has an electrophotographic speed, determined as described below, in the range of from 0.8 to 1.0 cm²/ergs; or preferably from 0.9 to 1.2 cm²/ergs. The high speed cocrystallized mixture of TiOPc and TiOFPc is referred herein as “high speed cocrystallized mixture”.

In the method of the invention, the low and high-speed pigments are mixed so as to provide a desired ratio of low to high pigment. The method of the invention is not limited to low and high-speed pigments that are “pure” or substantially “pure”. It is not critical to the invention that a pigment could be further purified. For example, a low speed pigment could include a percentage of high-speed pigment as a contaminant. This would limit the range of speeds available on mixing low and high-speed pigments, but would not otherwise present a problem.

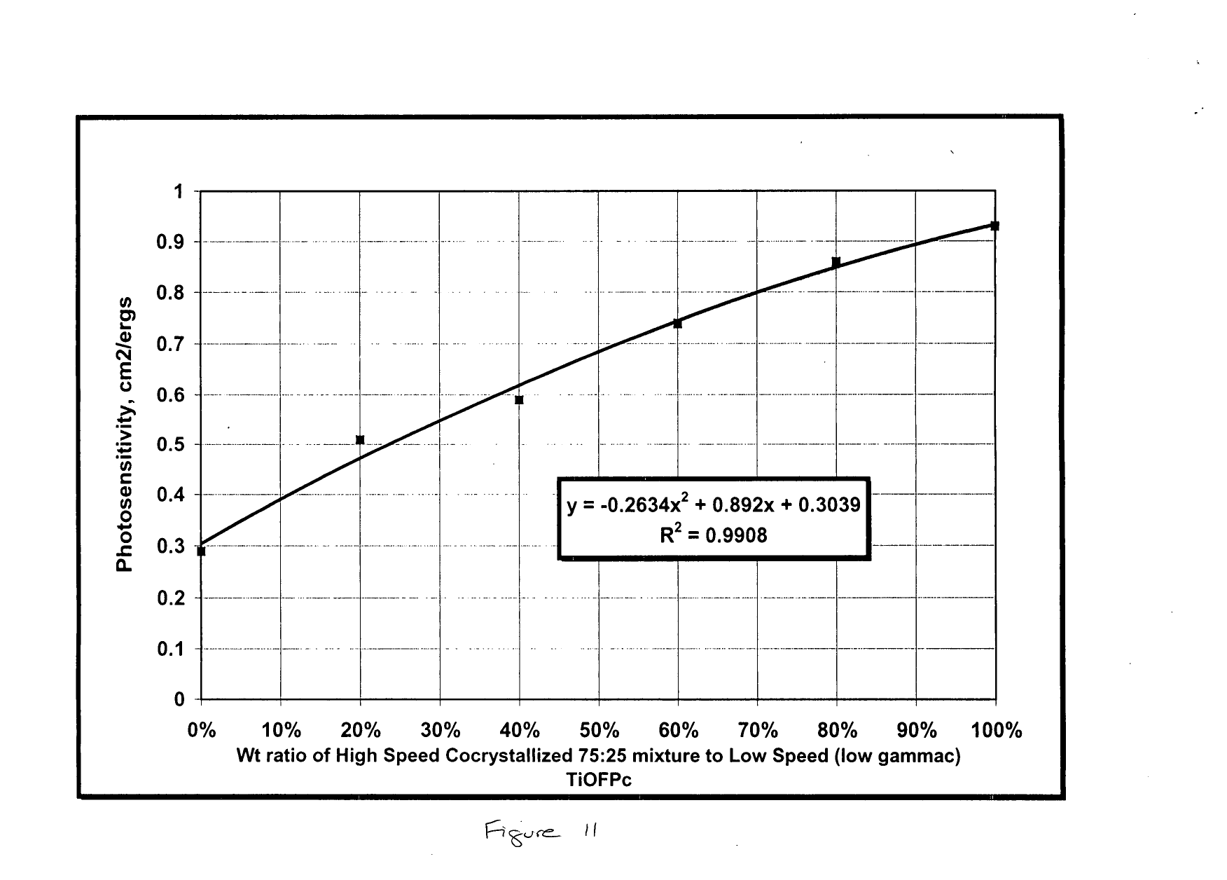

The electrophotographic elements of the invention have a sensitivity or speed that reflects the combination of low speed and high-speed pigments. Surprisingly, unlike previously reported combinations of fluorophthalocyanine pigments, the electrophotographic elements of the invention do not show a net increase in sensitivity nor do they show about the same sensitivity as either of the two different pigments. The electrophotographic recording elements of the invention instead demonstrate sensitivities, which are somewhere between the speeds of elements prepared using only high or low speed pigment. The sensitivities are not additive of the expected speeds for the relative weight fractions of the low speed and high speed pigments, but instead follow a more complex function. An examples of a graph that functions for one particular embodiment of the invention is shown in FIG. 11 and discussed below in relation to the example.

The method of preparation of the low speed and high speed pigments is not critical to the practice of the invention as long as the pigment produced has an appropriate x-ray spectrum and meets the ordinary requirements of electrophotographic use, in terms of dispersibility, contaminants, and the like. In a preferred embodiment of the invention, the low and high speed pigments are produced by procedures in which crude pigment is first rendered amorphous and then is treated with a solvent having a low gamma_{c} hydrogen bonding parameter, to prepare low speed titanyl phthalocyanine pigment, or high speed Co-Crystallized titanyl phthalocyanine:titanyl fluorophthalocyanine pigment mixture; or with a solvent having a high gamma_{c} hydrogen bonding parameter, to prepare lower speed titanyl phthalocyanine pigment, it is currently preferred that the high gamma_{c} be 10 or greater and that the low gamma_{c} be 7 or less.

Gamma_{c} hydrogen bonding parameter values of organic solvents can be determined by the method reported in “A Three-Dimensional Approach to Solubility”, J. D. Crowley, G. S. Teague, and J. W. Lowe, Journal of Paint Technology, Vol. 38, No. 496, May 1966, pp. 269-280, and further described in CRC Handbook of Solubility Parameters and Other Cohesion Parameters, A. Barton, CRC Press, Boca Raton,m Fla., 1983, pp. 174 and 179-180, and in the ASTM D3132 standard test method. The method comprises measuring the effect of the solvent on deuterated methanol in terms of the frequency of the infrared radiation absorbed by the O-D bond of deuterated methanol and comparing that effect to the effect of benzene on the same bond. The value of the gamma_{c} hydrogen bonding parameter for the solvent being tested is then determined in accordance with the equation:
gamma_{c}={(ν_{benzene})−(νₛₒₗᵥₑₙₜ)})/10
where “ν_{benzene}” is the wave number (expressed as cm⁻¹) of the infrared radiation absorbed by the O-D bond of deuterated methanol in contact with benzene, and “νₛₒₗᵥₑₙₜ” is the wave number of the infrared radiation absorbed by the O-D bond of deuterated methanol in contact with the solvent being tested.

Gamma_{c} hydrogen bonding parameter values of numerous organic solvents have been determined. A list for some common solvents is presented in Table 1.

TABLE 1

| | Gamma_{c} hydrogen |
|---|---|
| Solvent | bonding parameter value |
| benzene | 0.0 |
| dichloromethane | 1.5 |
| 1,1,2-trichloroethane | 1.5 |
| chlorobenzene | 1.5 |
| dichloropropane | 1.5 |
| chloroform | 1.5 |
| ethylene chloride | 1.5 |
| toluene | 4.5 |
| xylene | 4.5 |
| acetonitrile | 6.3 |
| methyl benzoate | 6.3 |
| anisole | 7.0 |
| diethyl ketone | 7.7 |
| methyl ethyl ketone | 7.7 |
| methyl isobutyl ketone | 7.7 |
| acetone | 9.7 |
| butylrolactone | 9.7 |
| dioxane | 9.7 |
| tetrahydrofuran | 9.9 |
| cyclohexanone | 11.7 |
| N,N-dimethylformamide | 11.7 |
| 2-ethoxyethanol | 13.0 |
| ethanol | 18.7 |
| methanol | 18.7 |
| butanol | 18.7 |
| pyridine | 18.1 |
| ethylene glycol | 20.6 |

The low speed phthalocyanine pigment can be one of the pigments produced by methods disclosed in U.S. Pat. Nos. 5,238,764 and 5,238,766, both to Molaire, both of which are hereby incorporated herein by reference, in which crude pigment is salt milled or acid pasted followed by dispersion in a solvent such as methanol or tetrahydrofuran, which has a gamma.sub.c hydrogen bonding parameter value greater than 9.0; or followed by dispersion in a solvent such as dichloromethane or methyl ethyl ketone, which has a gamma.sub.c hydrogen bonding parameter value less than 8.0. The low speed pigment used in the invention can also be a mixture of pigments, each of which demonstrates the characteristic x-ray peaks above indicated.

The low speed pigment can be one of the pigments produced by methods disclosed in U.S. patent application Ser. No. 10/655,113, filed on Sep. 4, 2003, in the names of Molaire, et al., entitled “Cocrystals Containing High-Chlorine Titanyl Phthalocyanine And Low Concentration Of Titanyl Fluorophthalocyanine, And Electrophotographic Element Containing Same” in which a process for forming an amorphous TiOPc/TiOFPc pigment mixture containing a low concentration of TiOFPc, said process comprising: subjecting a mixture comprising phthalonitrile and titanium tetrachloride to reaction conditions effective to form lightly chlorine-substituted crude crystalline Cl—TiOPc; combining said lightly chlorine-substituted crude crystalline Cl—TiOPc with crude crystalline TiOFPc in a weight ratio from about 70:30 Cl—TiOPc:TiOFPc to about 99.5:0.5 Cl—TiOPc:TiOFPc to form a crude crystalline pigment mixture; and treating said crude crystalline pigment mixture under conditions effective to form a substantially amorphous pigment mixture of Cl—TiOPc and TiOFPc. The low speed pigment used in the invention can also be a mixture of pigments, each of which demonstrates the characteristic x-ray peaks above indicated.

The high speed pigment can be one of the pigments produced by methods disclosed in U.S. Pat. Nos. 5,614,342 and 5,766,810 in which a method for preparing a co-crystallized titanyl phthalocyanine-titanyl fluorophthalocyanine composition comprising the steps of:

admixing crude unsubstituted titanyl phthalocyanine and crude titanyl fluorophthalocyanine to provide a pigment mixture;

increasing the amorphousness of said pigment mixture as determined by X-ray crystallography using X-radiation characteristic of Cu Kalpak. At a wavelength of 1.541 Å of the Bragg angle 2θ to provide an amorphous pigment mixture;

contacting said amorphous pigment mixture with organic solvent having a gamma_{c} hydrogen bonding parameter of less than 8.0 so as to produce cocrystals of said phthalocyanine and fluorophthalocyanine; and prior to said contacting, substantially excluding said amorphous pigment mixture from contact with organic solvent having a gamma hydrogen bonding parameter greater than 9.0.

The high speed pigment can be one of the pigments produced by methods disclosed in U.S. patent application Ser. No. 10/655,388, filed on Sep. 4, 2003, in the names of Molaire, et al., entitled “Two-Stage Milling Process For Preparing Cocrystals Of Titanyl Fluorophthalocyanine And Titanyl Phthalocyanine, And Electrophotographic Element Containing Same” in which a process for forming an amorphous mixture consisting essentially of TiOFPc and TiOPc and containing more than 75 weight percent TiOPc, said process comprising: forming a mixture of crude crystalline TiOFPc and crude crystalline, substantially chlorine-free TiOPc, said mixture containing less than 75 weight percent of substantially chlorine-free TiOPc; treating said mixture under conditions effective to form a substantially amorphous mixture of TiOFPc and TiOPc containing less than 75 weight percent of substantially chlorine-free TiOPc; treating said substantially amorphous mixture of TiOFPc and TiOPc with water; following drying said mixture, adding a further amount of crude crystalline, substantially chlorine-free TiOPc sufficient to form a new mixture containing more than 75 weight percent of substantially chlorine-free TiOPc; and treating said new mixture under conditions effective to form a substantially amorphous mixture of TiOFPc and TiOPc containing more than 75 weight percent of substantially chlorine-free TiOPc.

The high speed pigment can be one of the pigments produced by methods disclosed in U.S. patent application Ser. No. 655289, filed on Sep. 4, 2003, in the names of Molaire, et al., entitled “Process For Forming Cocrystals Containing Chlorine-Free Titanyl Phthalocyanines And Low Concentration Of Titanyl Fluorophthalocyanine Using Organic Milling Aid” in which a process for forming an amorphous pigment mixture consisting essentially of TiOPc and TiOFPc, said process comprising: combining a mixture of crude crystalline TiOPc and TiOFPc pigments in a weight ratio of at least 75:25 TiOPc:TiOFPc with at least about 5 wt. %, based on the total weight of TiOPc and TiOFPc, of an organic milling aid; and treating the mixture under conditions effective to form a substantially amorphous pigment mixture of TiOPc and TiOFPc containing at least about 75 weight percent TiOPc.

In the method of the invention, the low speed pigment, high speed pigment, binder and any desired addenda, are dissolved or dispersed together in a liquid to form an electrophotographic coating composition which is then coated over an appropriate underlayer. The liquid is then allowed or caused to evaporate to form the charge generation layer of the invention. As a matter of convenience, the low and high-speed pigments may or may not be mixed together before addition to the coating composition.

In a preferred embodiment of the invention two distinct electrophotographic coating compositions using the low speed and the high-speed pigments respectively are made. It is preferable, not necessary that both coating compositions used common binder, addenda or solvent. Then the two coating compositions are mixed in the appropriate ratio to produce final coating compositions with given photosensitivities.

This embodiment of the invention has economic and manufacturing flexibility advantages. Photosensitivities of the coating composition can be easily adjusted back and forth to different levels, allowing for manufacture of electrophotographic elements of various photosensitivies for various applications in a very economical manner.

The low speed pigment, binder and any desired addenda, are dissolved or dispersed together in a liquid to form an electrophotographic coating composition which is then coated over an appropriate underlayer. The liquid is then allowed or caused to evaporate to form the charge generation layer of the invention.

The electrophotographic elements of the invention can be of various types, including both those commonly referred to as single layer or single-active-layer elements and those commonly referred to as multiactive, or multi-active-layer elements. All of the electrophotographic elements of the invention have multiple layers, since each element has at least an electrically conductive layer and one photogenerating (charge generation) layer, that is, a layer which includes, as a charge generation material, a composition of matter including the high and low speed pigments of tile invention.

Single-active-layer elements are so named because they contain only one layer, referred to as the photoconductive layer that is active both to generate and to transport charges in response to exposure to actinic radiation. Such elements have an additional electrically conductive layer in electrical contact with the photoconductive layer. In single-active-layer elements of the invention, the photoconductive layer contains the charge generation material of the invention, which generates electron/hole pairs in response to actinic radiation and an charge-transport material, which is capable of accepting the charges and transporting them through the layer to effect discharge of the initially uniform electrostatic potential. The charge-transport agent, and low and high-speed pigments are dispersed as uniformly as possible in the photoconductive layer. The photoconductive layer also contains an electrically insulative polymeric film-forming binder. The photoconductive layer is electrically insulative except when exposed to actinic radiation.

Multiactive layer elements are so named because they contain at least two active layers, at least one of which is capable of generating charge, that is, electron/hole pairs, in response to exposure to actinic radiation and is, therefore, referred to as a charge-generation layer (CGL), and at least one of which is capable of accepting and transporting charges generated by the charge-generation layer and is therefore referred to as a charge-transport layer (CTL). Such elements typically comprise at least an electrically conductive layer, a CGL, and a CTL. Either the CGL or the CTL is in electrical contact with both the electrically conductive layer and the remaining CTL or CGL. The CGL contains a polymeric binder, and the charge generation material of the invention: low and high-speed pigment. The CTL contains a charge-transport agent and a polymeric binder.

Single-active-layer and multiactive layer electrophotographic elements and their preparation and use in general, are well known and are described in more detail, for example, in U.S. Pat. Nos. 4,701,396; 4,666,802; 4,578,334; 4,719,163; 4,175,960; 4,514,481; and 3,615,414, the disclosures of which are incorporated herein by reference.

In preparing the electrophotographic elements of the invention, the components of the photoconductive layer (in single-active-layer elements) or CGL (in multiactive layer elements), including binder and any desired addenda, are dissolved or dispersed together in a liquid to form an electrophotographic coating composition, which is then coated over an appropriate underlayer, for example, a support or electrically conductive layer. The liquid is then allowed or caused to evaporate from the mixture to form the permanent photoconductive layer or CGL. The titanyl fluorophthalocyanine pigment can be mixed with the solvent solution of polymeric binder immediately or can be stored for some period of time before making up the coating composition.

The polymeric binder used in the preparation of the coating composition can be any of the many different binders that are useful in the preparation of electrophotographic layers. The polymeric binder is a film-forming polymer having a fairly high dielectric strength. In a preferred embodiment of the invention, the polymeric binder also has good electrically insulating properties. The binder should provide little or no interference with the generation and transport of charges in the layer. The binder can also be selected to provide additional functions. For example, adhering a layer to an adjacent layer; or, as a top layer, providing a smooth, easy to clean, wear-resistant surface. Representative binders are film-forming polymers having a fairly high dielectric strength and good electrically insulating properties. Such binders include, for example, styrene-butadiene copolymers; vinyl toluene-styrene copolymers; styrene-alkyd resins; silicone-alkyd resins; soya-alkyd resins; vinylidene chloride-vinyl chloride copolymers; poly (vinylidene chloride); vinylidene chloride-acrylonitrile copolymers; vinyl acetate-vinyl chloride copolymers; poly (vinyl acetals), such as poly (vinyl Butyral); nitrated polystyrene; poly (methyl styrene); isobutylene polymers; polyesters, such as poly (ethylenecoakylenebis(alkyleneoxyaryl) phenylenedicarboxylate); phenol-formaldehyde resins; ketone resins; polyamides; polycarbonates; polythiocarbonates; poly {ethylen-coisopeopyliden-2,2-bis(ethylenoxyphenylene)terephthalate}; copolymers of vinyl haloacrylates and vinyl acetate such as poly(vinyl-m-bromobenzoatecovinyl acetate); chlorinated poly(olefins), such as chlorinated poly(ethylene); cellulose derivatives such as cellulose acetate, cellulose acetate butyrate and ethyl cellulose; and polyimides, such as poly {1,1,3-trimethyl-3-(4′-phenyl)-5-indane pyromellitimide}. Examples of binder polymers which are particularly desirable from the viewpoint of minimizing interference with the generation or transport of charges include: bisphenol A polycarbonates and polyesters such as poly[(4,4′-norbomylidene)diphenylene terephthalate-coazelate].

Suitable organic solvents for forming the polymeric binder solution can be selected from a wide variety of organic solvents, including, for example, aromatic hydrocarbons such as benzene, toluene, xylene and mesitylene; ketones such as acetone, butanone and 4-methyl-2-pentanone; halogenated hydrocarbons such as dichloromethane, trichloroethane, methylene chloride, chloroform and ethylene chloride; ethers including ethyl ether and cyclic ethers such as dioxane and tetrahydrofuran; other solvents such as acetonitrile and dimethylsulfoxide; and mixtures of such solvents. The amount of solvent used in forming the binder solution is typically in the range of from about 2 to about 100 parts of solvent per part of binder by weight, and preferably in the range of from about 10 to 50 parts of solvent per part of binder by weight.

In the coating composition, the optimum ratio of the charge generation material of the invention to binder or of charge generation material plus charge transport material to binder can vary widely, depending on the particular materials employed. In general, useful results are obtained when the total concentration of both charge generation material and charge transport material in a layer is within the range of from about 0.01 to about 90 weight percent, based on the dry weight of the layer. In a preferred embodiment of a single active layer electrophotographic element of the invention, the coating composition contains from about 10 to about 70 weight percent of an electron-transport agent and from 0.01 to about 80 weight percent of the charge generation material of the invention. In a preferred embodiment of a multiple active layer electrophotographic element of the invention, the coating composition contains from about 0 to about 80 weight percent of an electron-transport agent and from 0.01 to about 50 weight percent of charge generation material of the invention.

In a preferred embodiment of the invention the coating composition is prepared by the method of U.S. patent application Ser. No. 10/857,307 entitled “Newtonian Ultrasonic-Insenstive Charge Generating Layer Dispersion Composition and A Method For Producing The Composition” filed by Michel F. Molaire et al which is hereby incorporated herein by reference, in which a Newtonian, ultrasonic-insensitive charge generation dispersion composition comprising at least one finely-divided pigment, polyvinyl Butyral and a polyester ionomer wherein the composition has a low shear viscosity (measured at 0.5 s⁻¹) to high shear viscosity (measured at 1000 s⁻¹) ratio from about 1 to about 3.0 and wherein the viscosity ratio is either retained or decreased after sonication.

The coating composition of this invention can also be prepared by the method of U.S. patent application Ser No. 10/836,784 entitled “A Coating Solution Containing Cocrystals And Or Crystals Of A Charge-Generation Pigment Or A Mixture Of Charge-Generation Pigments” filed by Michel F. Molaire et al which is incorporated herein by reference in which provides a method for preparing an electrophotographic element coating solution containing a crystallized charge-generation pigment material, the method comprising: dry milling a crude charge-generation pigment material to produce a finely-divided amorphous pigment material; contacting the amorphous pigment material with a first solvent having a gamma_{c} hydrogen bonding parameter ether less than 9 or greater than 9, and optionally a dispersant material to produce a finely-divided crystalline charge-generation pigment; and, mixing a binder and a second solvent with the charge-generation crystalline pigment without isolating the crystalline pigment to produce the coating solution.

The photosensitivity of electrophotographic elements, as discussed above, is a function of both the charge generation material and the thickness of the charge generation layer. At very low thickness, the photosensitivity of the electrophotographic element of the invention is a steep function of charge generation layer thickness. As the thickness is increased, a point is reached where photosensitivity is invariant to increase in thickness. This is advantageous for manufacturing, since tolerances in the thickness of the charge generation layer are no longer critical. In the invention, the thickness of the charge generation layer can be chosen to be well above the region of photosensitivity dependent upon charge generation layer thickness. In a preferred embodiment of the invention, the charge generation layer has such a thickness; the charge generation layer is coated at a thickness from 0.25 micron to about 5 microns, depending on the concentration of the pigment.

Polymeric binders useful for the CGL or photoconductor layer can also be used in producing a CTL. Any charge transport material can be utilized in elements of the invention. Such materials include inorganic and organic (including monomeric organic, metallo-organic and polymeric organic) materials); for example, zinc oxide, lead oxide, selenium, phthalocyanine, perylene, arylamine, polyarylalkane, and polycarbazole materials, among many others. The CTL can be solvent coated or can be produced in some other manner, for example, by vacuum deposition.

CGL's and CTL's in elements of the invention can optionally contain other addenda such as leveling agents, surfactants, plasticizers, sensitizers, contrast control agents, and release agents, as is well known in the art.

Various electrically conductive layers or supports can be employed in electrophotographic elements of the invention, for example, paper (at a relative humidity above 20 percent) aluminum-paper laminates; metal foils such as aluminum foil, zinc foil, and the like; metal plates such as aluminum, copper, zinc, brass and galvanized plates; vapor deposited metal layers such as silver, chromium, vanadium, gold, nickel, aluminum and the like; and semiconductive layers such as cuprous iodide and indium tin oxide. The metal or semiconductive layers can be coated on paper or conventional photographic film bases such as poly(ethylene terephthalate), cellulose acetate, polystyrene, etc. Such conducting materials as chromium, nickel, etc. can be vacuum-deposited on transparent film supports in sufficiently thin layers to allow electrophotographic elements so prepared to be exposed from either side.

Electrophotographic elements of the invention can include various additional layers known to be useful in electrophotographic elements in general, for example, subbing layers, overcoat layers, barrier layers, and screening layers.

The following Examples and Comparative Examples are presented to further illustrate some preferred modes of practice of the invention.

Preparation 1—Crude Substantially Chlorine-Free Titanyl Phthalocyanine (TiOPc)

Crude substantially chlorine-free titanyl phthalocyanine was prepared as described in Preparation 1 of U.S. patent application Ser. No. 10/655,388, filed on Sep. 4, 2003,

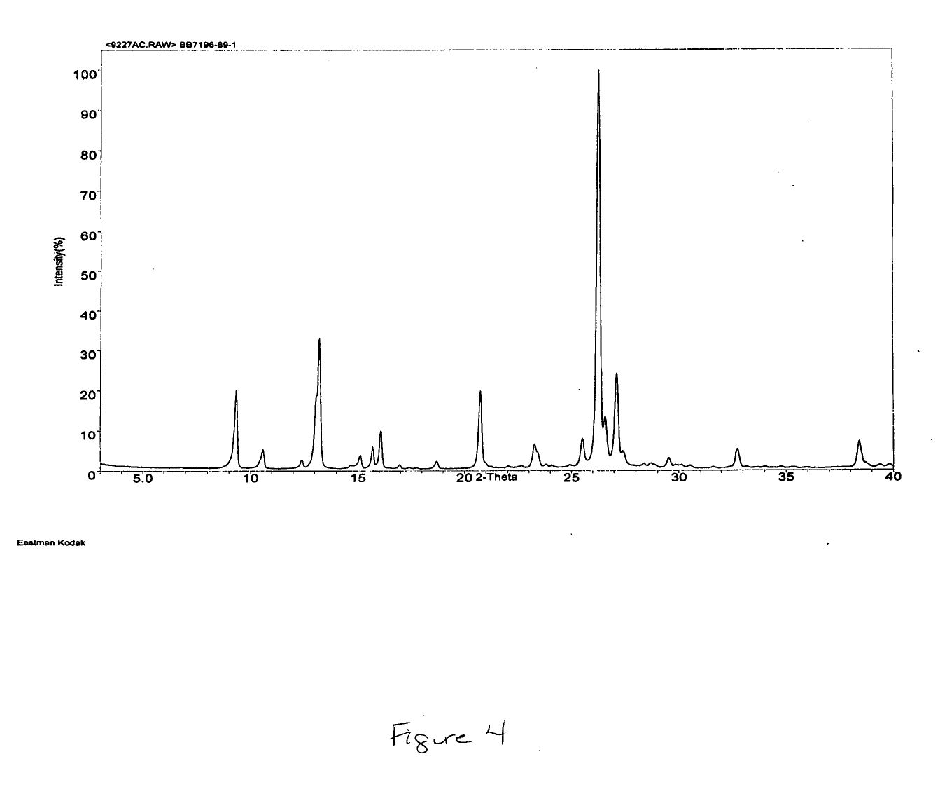

Phthalonitrile (1280 g), benzamide (1512.5 g), xylene (1250 ml), and pentanol (1052 g) were added in that order into a 12-liter 3-necked round-bottomed flask equipped with a temperature probe and temperature controller, a condenser, and a paddle stirrer. After the stirrer was started, titanium (IV) butoxide (838 g), and xylene (1000 ml) were added. The reaction mixture was heated to reflux (144° C.) for six hours, then cooled to 85° C., and filtered through a medium frit sintered glass funnel. The pigment was rinsed first with 4×500-ml portions of toluene and then with 4×500-ml portions of hot dimethylformamide. After an overnight soak in dimethylformamide, the mixture was heated at reflux in that solvent for one hour. The product was collected and washed with methanol and acetone, then dried at 70-80° C. overnight. Neutron activation indicated 8.6±0.02 wt % titanium and less than 0.01 wt. % chlorine. The X-ray spectrum is shown in FIG. 4.

Preparation 2—Crude Titanyl Tetrafluorophthalocvanine (TiOFPc)

Crude titanyl tetrafluorophthalocyanine was prepared as described in Preparation 2 of U.S. Pat. No. 5,614,342. Preparation of Crude Titanyl Tetrafluorophthalocyanine

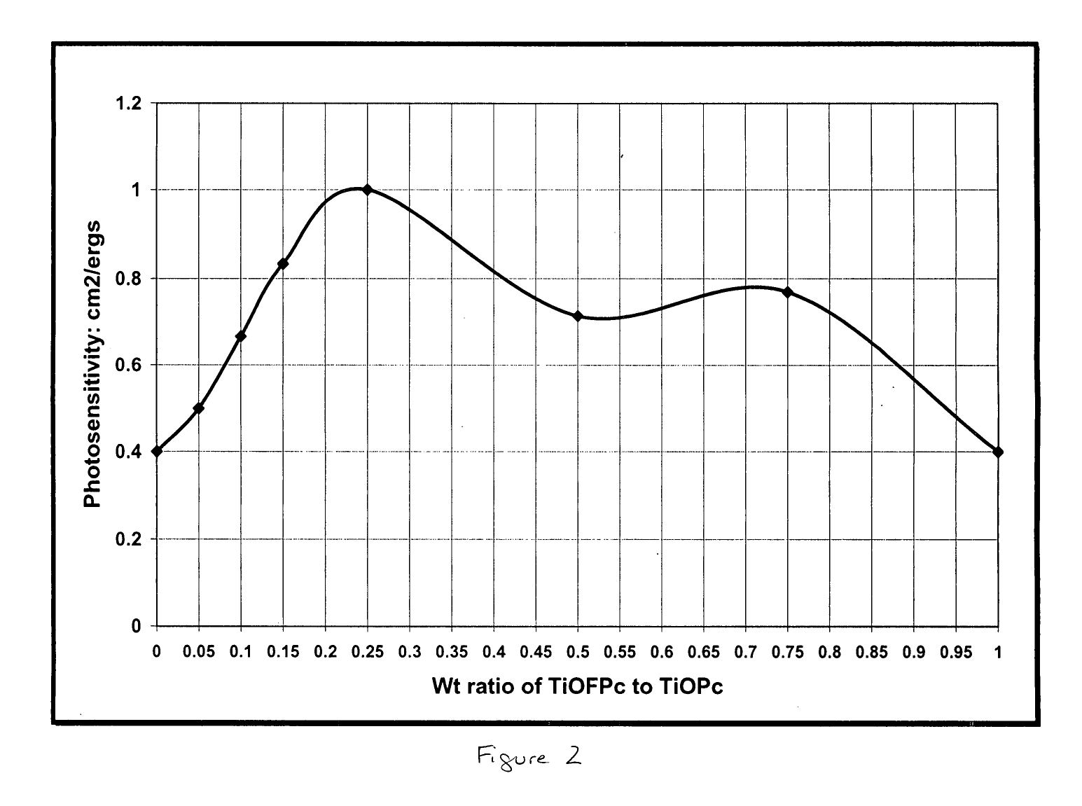

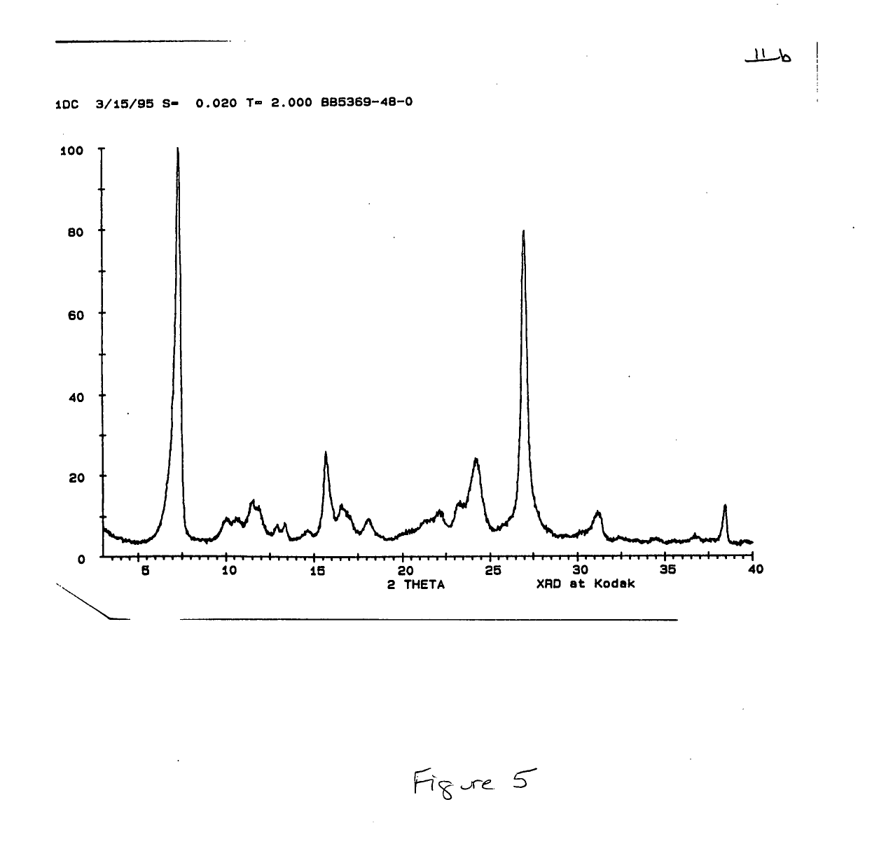

Fluorophthalonitrile (38.7 grams, 0.267 mole) and titanium tetrachloride (20.7 grams, 0.134 mole) were suspended in 200 ml of 1-chloronaphthalene and heated to 205.degree..±0.5.degree. C. and maintained for 2 hours at this temperature. The reaction mixture was cooled slightly, and the dark solid was collected and washed with acetone and methanol. The dark blue solid (34 grams) was refluxed in water several times until the filtrate was neutral. The pigment was rinsed with acetone and methanol, and dried to yield crude titanyl tetrafluorophthalocyanine. The x-ray diffraction spectrum (FIG. 2) exhibited major peaks of the Bragg angle at 7.4°, 10.6°, 11.5°, 11.8°, 15.8°, 16.5°, 18.1°, 23.2°, 24.3°, 27.1°, 31.2° (all ±0.2°) The X-ray spectrum is shown in FIG. 5

Preparation 3—Crude High-Chorine Titanyl Phthalocyanine (Cl—TiOPc)

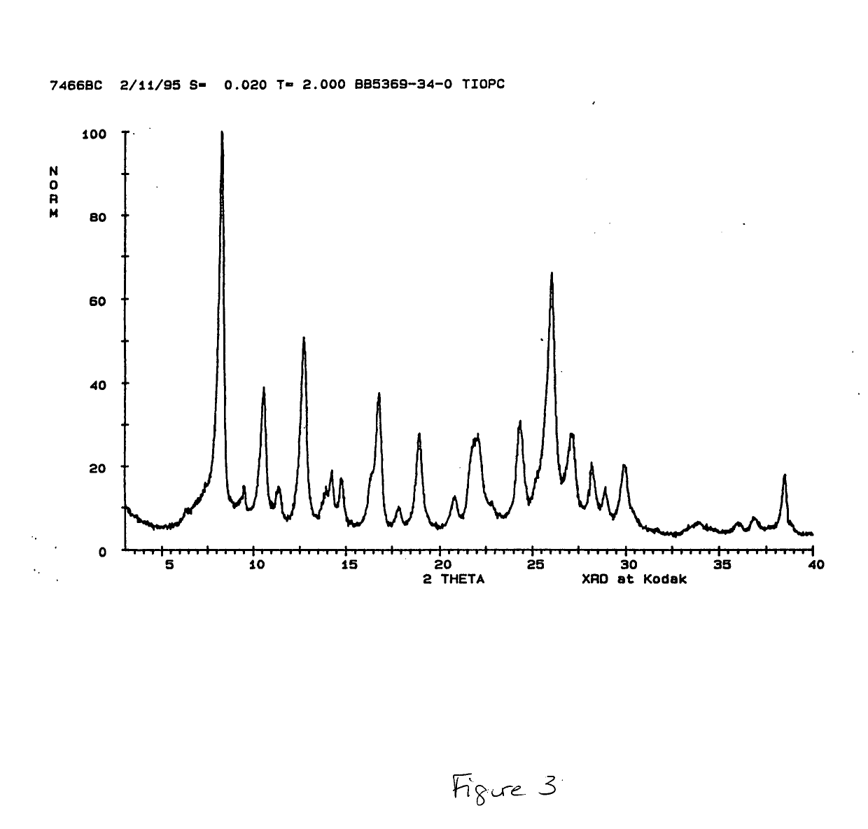

Crude high-chlorine titanyl phthalocyanine was prepared as described in Preparation 4 of U.S. patent application Ser. No. 10/655,113, filed on Sep. 4, 2003, in the names of Molaire, et al.; entitled “Cocrystals Containing High-Chlorine Titanyl Phthalocyanine And Low Concentration Of Titanyl Fluorophthalocyanine, And Electrophotographic Element Containing Same”. The X-ray spectrum is shown in FIG. 3.

The crude TiOPc, TiOFPc and Cl—TiOPc pigments prepared as just described were employed in the following illustrative examples of the invention.

Preparation 4—High Speed Cocrystalline 75/25 Mixture

A 1-gallon wide-mouth glass jar was charged with 9 kg of 3 mm stainless steel balls, 56.25 g (75 wt %) TiOPc made by Preparation 1 and 18.75 g (25 wt %) TiOFPc made by Preparation 2. The jar was put on a roller mill at 85 rpm, and milling was carried out for 120 hours, at which time a small sample was removed and treated with water. The sample was separated and dried and subjected to x-ray analysis. The resulting plot demonstrates that the mixture is fully amorphized.

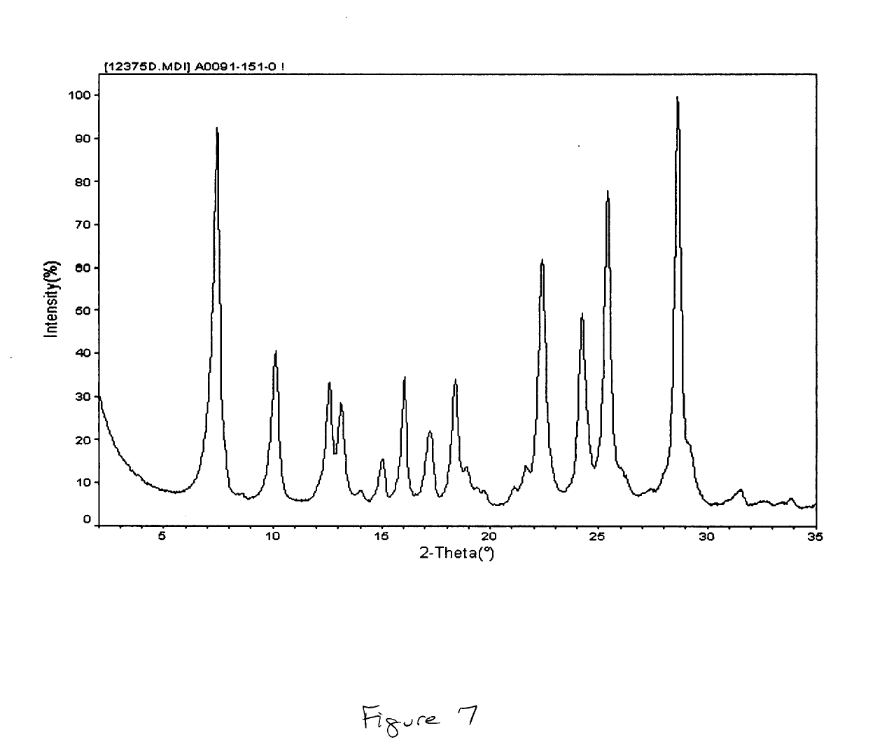

To the bulk of the sample in the jar was added 1500 ml of dichloromethane. The mixture was further milled for 24 hours, and the beads were separated from the dichloromethane pigment slurry. The pigment was collected by filtration, dried, and subjected to X-ray analysis. Its spectrum, shown in FIG. 7, depicts a typical pattern for a cocrystallized TiOPc/TiOFPc mixture.

Preparation 5—High Speed Cocrystallized 85/15 Mixture

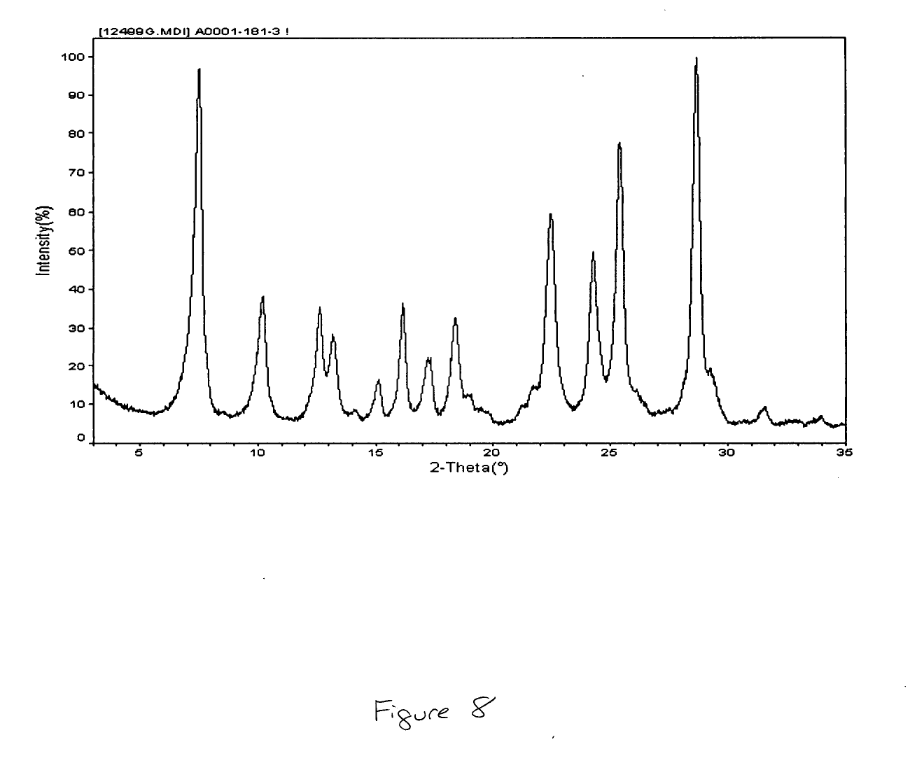

The procedure of preparation 4 was followed, except that 63.75 g (85 wt %) of TiOPc and 11.25 g. (15 wt %) of. TiOFPc were used. The X-ray spectrum is shown in FIG. 8.

Preparation 6—Low Speed (Low Gamma_{c}) TiOFPc

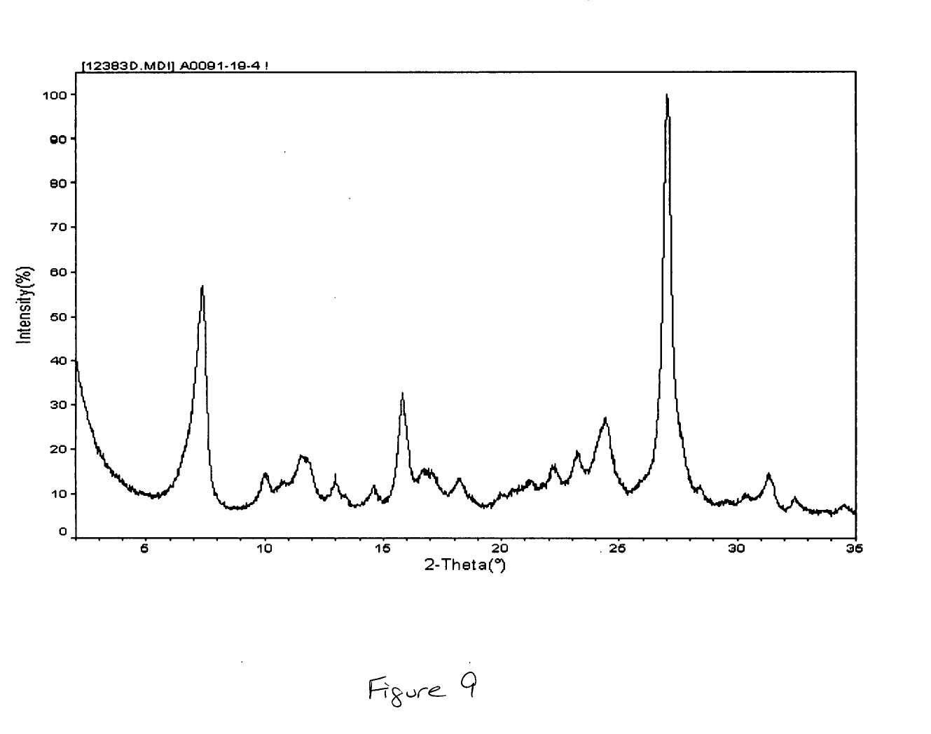

The procedure of preparation 4 was followed except that 75 g of titanyl tetrafluorophthalocyanine was used. The X-ray spectrum is shown in FIG. 9

Preparation 7—Low Speed (High Gamma_{c}) TiOFPc

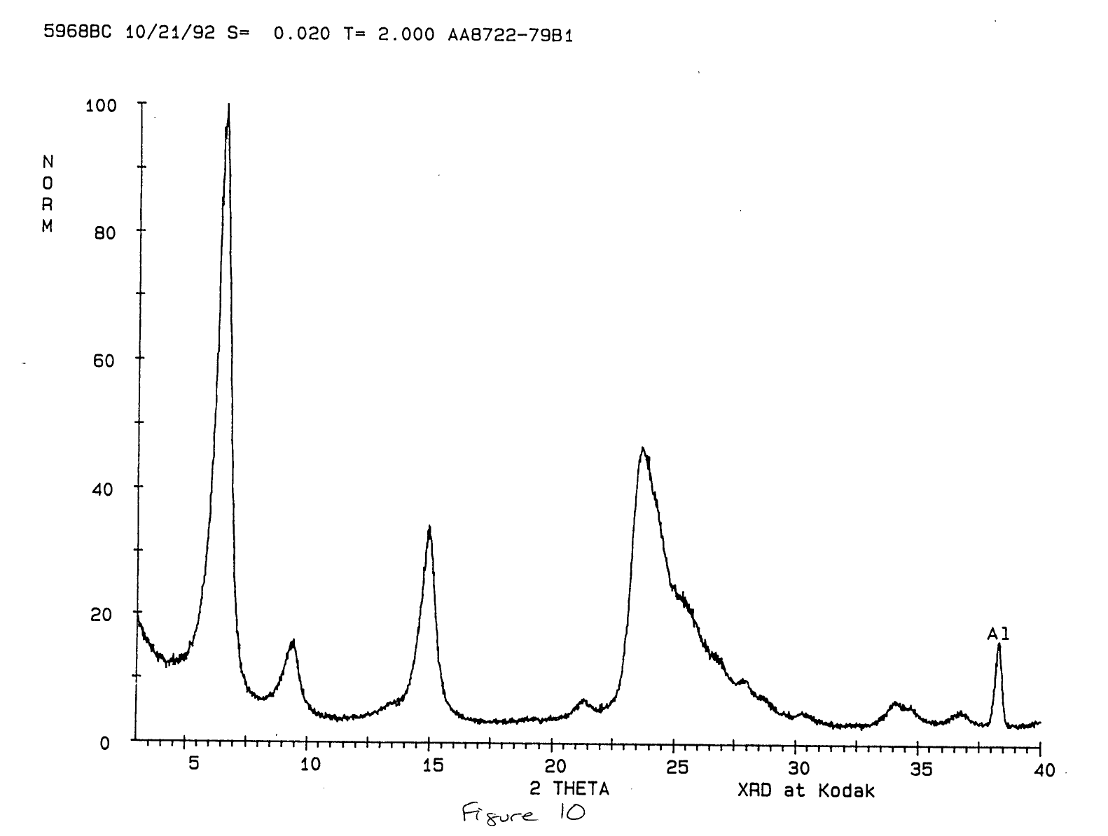

The procedure of preparation 4 was followed except that methanol having a gamma_{c} of 18.7 was used as the crystallizing solvent. The X-ray pectrum is shown in FIG. 10

Preparation 8—Low Speed Cl—TiOPc

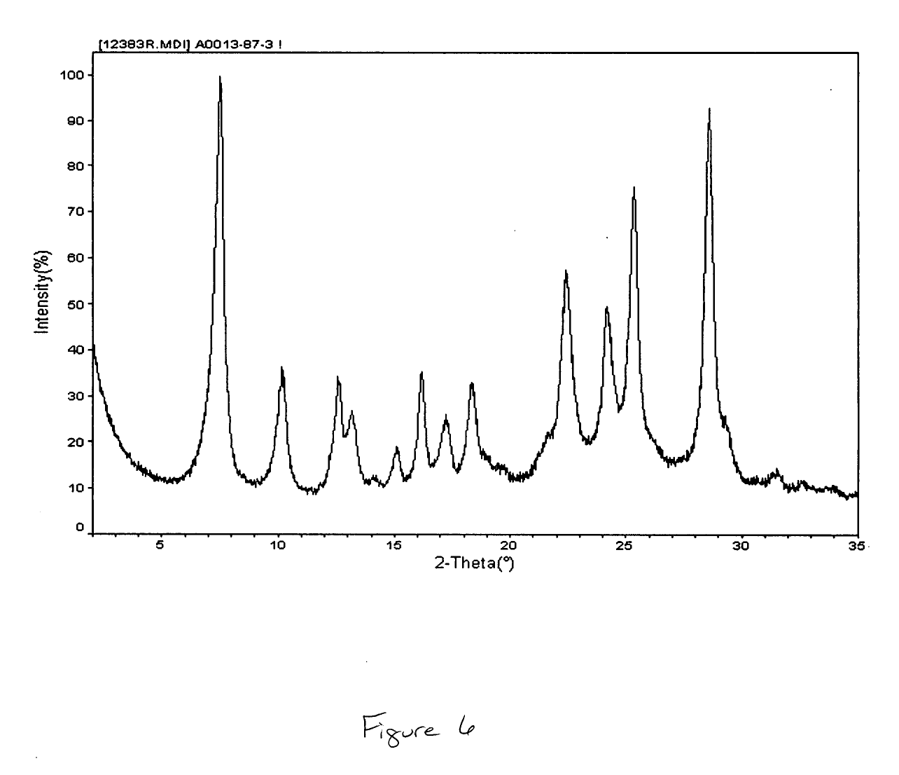

The procedure of preparation 4 was followed except that 75 g of Cl—TiOPc was used. The X-ray spectrum is shown in FIG. 6.

Dispersion Preparation 1—High Speed Coating Dispersion Containing High Speed Cocrystallized 75:25 Mixture

To a SZEGVARI attritor type 1SDG, size 1, manufactured by Union Process, of Akron, Ohio, 1314 g of 1,1,2-Trichloroethane, and 850 g of a 4 Wt % of a polyvinyl Butyral S-Lec BM-2 (having a Butyral content of 85.6%, and alcohol of 12.1%) in 1,1,2-Trichloroethane were added with the attritor set at 100 RPM, and 136 g. of the high speed co-crystalline mixture of TiOPc and TiOFPc:75:25 of preparation 4 were added to the attritor. After complete addition of the pigment, the attritor speed was increased to 175 RPM. The mixture was milled for six hours.

Then the contents of the attritor were discharged into a tarred jar, leaving the stainless steel beads behind. The attritor was rinsed twice with 975.6 g of 1,1,2-trichloroethane into the same jar. The recovered mill grind was then added to 2550 g of a 4% of the polyester ionomer made from isophthalic acid (95 mole %), 4-sodio-isophthalic sulfonate (5 mole %), diethylene glycol (20 mole %), and neopentyl glycol (80 mole %), in 1,1,2-trichloroethane. To the stirred dispersion, 1.8 gram of the surfactant DC-510 from Dow Corning was added. The dispersion was finally filtered with a 40 microns Pall filter.

The resulting dispersion was characterized using the rheological measurement procedure described above. The 0.75 and 0.9 ratios are characteristics of a Newtonian dispersion insensitive to ultrasonic treatment.

Dispersion Preparation 2—Low Speed Coating Dispersion Containing Low Speed (Low Gamma_{c}) TiOFPc

The procedure of comparative example 1 was followed, except that the low speed pigment was made according to preparation 6.

Dispersion Preparation 3—Low Speed Coating Dispersion Containing Low Speed Cl—TiOPc

The procedure of comparative example 1 was followed, except that the low speed Cl—TiOPc pigment made according to preparation 6.

### COMPARATIVE EXAMPLE 1-3

Electrophotographic elements were prepared using, as a support, a 175-micrometer thick conductive film having a thin layer of nickel deposited on a poly (ethylene terephtalate) substrate. The bare film was first undercoated, using a hopper coating machine, with a barrier layer of a polyamide resin marketed by Toray Chemical Inc. of Japan as Amilan CM8000, (2% weight/weight solution) in ethanol solvent with the hopper coating machine set at an application rate of 0.05 grams (dry)/ft.sup.2.

The dispersion of dispersion preparation 1 (comparative example 1), 2 (comparative example 2) or 3 (comparative example 3), were respectively coated onto the undercoated film using the hopper coating machine operated at 0.045 grams (dry)/ft.sup. 2 to form a charge generation layer (CGL).

The CGL was overcoated using the hopper coating machine at 2.3 grams (dry)/ft.sup.2 with a solution of polyester formed from 4,4′(2-norbornylidene) diphenol and a 40/60 molar ratio of terephtahlic/azelaic acids (10 parts by weight), a polycarbonate sold by the Mobay Company under the trade name Makrolon (40 parts by weight), 1,1-bis{4-(di-4-tolylamino)phenyl}cyclohexane (50 parts by weight), dissolved in dichloromethane.

The resulting electrophotographic elements were then evaluated as follows. Red and near infrared photosensitivity was determined by electrostatiscally corona-charging the electrophotographic element to an initial potential of −500 volts and exposing the element to filtered light (narrow band pass) at a wavelength of 775 nm from a xenon flash lamp (160 microsecond flashes), in an amount sufficient to photoconductively discharge the initial potential down to a level of −250 volts. Photosensitivity (also referred to as photographic speed) was measured in terms of the amount of incident actinic radiant energy (expressed in ergs/cm.sup.2) needed to discharge the initial voltage down to the desired level of −250 volts. The lower the amount of radiation needed to achieve the desired degree of discharge, the higher is the photosensitivity of the element. Dark decay was determined by letting an unexposed area of the film spontaneously discharge in the dark for seven seconds. The dark decay was calculated by dividing the amount of dark discharge (after seven seconds) by seven. Results appear in Table 2

### EXAMPLES 1-4

The procedures of comparative examples 1-3 were repeated except that the high-speed cocrystallized dispersion of preparation 1 was mixed with the low speed (low gamma_{c}) of dispersion preparation 2 in the ratio described in Table 2.

TABLE 2
Mixture of High Speed CoCrystallized Mixture
75:25 and Low-Speed (low gamma_{c} TiOFPc)

| Example or | | Speed | Speed | Dark |
|---|---|---|---|---|
| Comparative | Fast | (ergs/cm² at | (cm²/ergsat | decay |
| Example | Pigment(wt/wt %) | 50%) | 50%) | (volts/sec) |
| C Ex. 1 | 0 | 3.4 | 0.29 | 1.2 |
| Ex. 1 | 20 | 2.0 | 0.51 | 0.7 |
| Ex. 2 | 40 | 1.7 | 0.59 | 1.2 |
| Ex. 3 | 60 | 1.4 | 0.74 | 1.7 |
| Ex. 4 | 80 | 1.2 | 0.86 | 2.2 |
| C Ex. 2 | 100 | 1.1 | 0.93 | 3 |

Additional electrophotographic elements, incorporating high speed and low speed pigments prepared by different procedures produced comparable results to those described in the Examples.

While specific embodiments of the invention have been shown and described herein for purposes of illustration, the protection afforded by any patent which may issue upon this application is not strictly limited to a disclosed embodiment; but rather extends to all modifications and arrangements which fall fairly within the scope of the claims which are appended hereto.

What is claimed is:

1. An electrophotographic element comprising a charge generation layer including binder and, dispersed in said binder, a physical mixture of:
a high speed co-crystallized mixture of TiOPc and TiOFPc having a first intensity peak at 7.4 with respect to X-rays characteristic of Cu Kα at a wavelength of 1.541 Å of the Bragg angle 2θ and a second intensity peak at 28.6°±2°; and
a lower speed phthalocyanine pigment.

2. The electrophotographic element of claim 1 wherein said charge generation layer has a red and near infrared photosensitivity between the photo sensitivities of a charge generation layer having only said high speed co-crystallized mixture of TiOPc and TiOFPc and a charge generation layer having only said low speed phthalocyanine pigment; wherein said photosensitivity is determined by electrostatiscally corona-charging to an initial potential of −500 volts and exposing to monochromatic light at a wavelength of 775 nm, in an amount sufficient to photo conductively discharge the initial potential to a level of −250 volts.

3. The electrophotographic element of claim 1 wherein said element is a single active layer element.

4. The electrophotographic element of claim 1 wherein said element is a multiple active layer element.

5. The electrophotographic element of claim 1 wherein said high speed cocrystallized mixture of TiOPc and TiOFPc exhibits peaks of the Bragg angle 2θ with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6°.

6. The electrophotographic element of claim 1 wherein said high-speed co-crystallized mixture has a relative weight/weight ratio of TiOPc to TiOFPc of 75:25.

7. The electrophotographic element of claim 1 wherein said high-speed co-crystallized mixture has photosensitivity between 0.7 to 1.2 cm²/ergs.

8. The electrophotographic element of claim 1 wherein said low speed phthalocyanine pigment is titanyl fluorophthalocyanine having a first intensity peak with respect to X-rays characteristic of Cu Kα at a wavelength of 1.541 Å of the Bragg angle 2θ at 27°±0.2°, and a second intensity peak at 7.3°±0.2°, said second peak having intensity relative to said first peak of less than 60 percent.

9. The electrophotographic element of claim 1 wherein said low speed phthalocyanine pigment is TiOFPc having a first intensity peak with respect to X-rays characteristic of Cu Kα at a wavelength of 1.541 Å of the Bragg angle 2θ at 6.7 and a second intensity peak at 23.7. The second peak has intensity relative to the first peak of less than 50 percent.

10. The electrophotographic element of claim 1 wherein said low speed phthalocyanine pigment is crystalline Cl—TiOPc exhibiting major peaks of the Bragg angle 2θ at 7.3°, 10.0°, 11.6°, 12.9°, 15.8°, 16.9°, 18.1°, 23.1°, 24.2°, 27.0°, and 31.17° (all ±0.2°).

11. The electrophotographic element of claim 1 wherein said physical mixture has a relative weight/weight ratio of said high speed co-crystallized mixture of TiOPc and TiOFPc to said low speed phthalocyanine pigment of from 99:1 to 1:99.

12. The electrophotographic element of claim 1 wherein said charge generation layer comprises:
a first preformed coating composition including binder and, dispersed in said binder the said high-speed co-crystallized mixture of TiOPc and TiOFPc;
a second preformed coating composition including binder and dispersed in said binder the said low speed crystalline phthalocyanine pigment;
said first, and said second preformed coating composition mixed together in proportion to produce a physical mixture of a chosen weight/weight ratio of said high speed co-crystallized mixture of TiOPc and TiOFPc to said low speed crystalline phthalocyanine pigment.

13. The electrophotographic element of claim 1 wherein said charge generation layer was prepared by pre mixing said high speed co-crystallized mixture of TiOPc and TiOFPc and said low speed crystalline phthalocyanine pigment before said dispersing in said binder.

14. The electrophotographic element of claim 1 wherein said binder comprises is a mixture of polyvinyl Butyral and a polyester ionomer.

15. The electrophotographic element of claim 14 wherein said polyvinyl Butyral is supplied as a copolymer containing moieties of Butyral, vinyl alcohol and vinyl acetate.

16. The electrophotographic element of claim 15 wherein the Butyral content of the copolymer is below 90 mole percent Butyral.

17. A coating composition comprising a mixture of:
a high-speed co-crystallized mixture of TiOPc and TiOFPc exhibits peaks of the Bragg angle 2θ with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6°;
a slow titanyl fluorophthalocyanine having a first intensity peak with respect to x-rays of Cu Kα at a wavelength of 1.541 Å of the Bragg angle 2θ at 27°, and a second intensity peak at 7.3°, said second peak having intensity relative to said first peak of less than 60 percent; and a solvent.

18. A coating composition comprising a mixture of:
a high speed cocrystallized mixture of TiOPc and TiOFPc exhibits peaks of the Bragg angle 2θ with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6°;
a slow TiOFPc having a first intensity peak with respect to X-rays characteristic of Cu Kα at a wavelength of 1.541 Å of the Bragg angle 2θ at 6.7 and a second intensity peak at 23.7 wherein the second intensity peak has an intensity relative to the first intensity peak of less than 50 percent.

19. A coating composition comprising a mixture of:
a high speed cocrystallized mixture of TiOPc and TiOFPc exhibits peaks of the Bragg angle 2.theta. with respect to x-rays of Cu Kα at a wavelength of 1.541 Å at 7.4°, 10.1°, 12.6°, 13.1°, 15.0°, 16.0°, 17.2°, 18.4°, 22.4°, 24.3°, 25.4°, 28.6°;
a slow crystalline Cl—TiOPc exhibiting major peaks of the Bragg angle 2θ at 7.3°, 10.0°, 11.6°, 12.9°, 15.8°, 16.9°, 18.1°, 23.1°, 24.2°, 27.0°, and 31.17°; and a solvent.
